(19) United States
(12) Patent Application Publication
(10) Pub. No.: US 2015/0048200 A1
(43) Pub. Date: Feb. 19, 2015

(54) HIGH-SPEED VTOL AIRCRAFT

(71) Applicant: Geoffrey Byron Greene, Memphis, TN (US)

(72) Inventor: Geoffrey Byron Greene, Memphis, TN (US)

(21) Appl. No.: 14/459,874

(22) Filed: Aug. 14, 2014

Related U.S. Application Data
(60) Provisional application No. 61/959,065, filed on Aug. 14, 2013.

(51) Int. Cl. B64C 29/00

(52) U.S. Cl. CPC B64C 29/00
USPC 244/12.1

(57) ABSTRACT

This invention can take-off like a helicopter and then roll forward as a single unit to fly faster and further than any conventional helicopter. Just like the seats in a Ferris wheel, the payload of passengers or freight can remain upright and comfortable as this aircraft rotates from take-off to fast forward and back to landing mode. Prior inventions claiming similar performance generate lift for take-off and landing by relative rotation of major aircraft components or by vectoring a thrust through large angles of deflection which produces inherently unstable flight characteristics. This invention requires neither rotation of major assemblies nor highly vectorable thrust, making it simpler and more reliable than the aircraft with major rotating assemblies and more stable and efficient than aircraft relying on vectored thrust for lift.

### BACKGROUND—CROSS-REFERENCE TO RELATED APPLICATIONS

Not applicable

### BACKGROUND—FIELD OF THE INVENTION

This invention relates to vertical take-off and landing aircraft, specifically one that flies much faster and more efficiently than a helicopter.

### SEQUENCE LISTING

Not applicable.

### BACKGROUND—DISCUSSION OF PRIOR ART

Forward flight speed of a conventional helicopter is limited by the aerodynamics of its rotor blades. To achieve higher-speed forward flight, existing Vertical Take-Off and Landing (VTOL) aircraft typically rotate major components such as engines, rotors, and/or wings with respect to each other. This ability to reconfigure major aircraft components in flight adds weight, increases complexity, increases both cost of production and cost of maintenance, and reduces reliability.

### SUMMARY

This invention is capable of true vertical take-off. Transition to high-speed forward-flight is accomplished without changing the aircraft's basic configuration as defined by its major components, (e.g., fuselage, wing, propeller, engines). Transition is accomplished by rotating the unit as a whole about an axis oriented along the length of the fixed wing. Only minor elements such as sensors, displays, controls, lights, seats, or beds may rotate with respect to the major aircraft components to maintain preferred orientation of that minor element.

### OBJECTS AND ADVANTAGES

Accordingly, several objects and advantages of the present invention are:
(a) Faster forward flight and more efficient than a conventional helicopter;
(b) Less expensive to produce and maintain than existing VTOL aircraft;
(c) More reliable than existing VTOL aircraft;
(d) More efficient than existing VTOL aircraft.

### DESCRIPTION OF DRAWINGS

FIG. 1 is a perspective view of a basic embodiment of my aircraft's unique arrangement of fuselage, propeller and wings in vertical flight mode resembling a helicopter with a fixed wing attached in a fashion similar to attachment of a fin to a rocket.

FIG. 2 is a top view of the same embodiment in vertical take-off and landing mode.

FIG. 3 is a top view looking down on the same embodiment sitting on the ground in vertical take-off and landing mode ready to fly up toward the viewer.

FIG. 4 is a perspective view of the same embodiment rotated to fast-forward flight mode flying toward the right of the viewer.

FIG. 5 is a front view of the same embodiment in fast-forward flight mode flying toward the viewer.

FIG. 6 is a top view looking down on the same embodiment in fast-forward flight mode flying toward the right of the viewer.

### DESCRIPTION AND OPERATION OF THE INVENTION

The purpose of this invention is to provide an aircraft with good vertical take-off and landing capabilities, a bonus of slow flight in any direction, and the ability to rotate into an aircraft that flies much faster than a conventional helicopter.

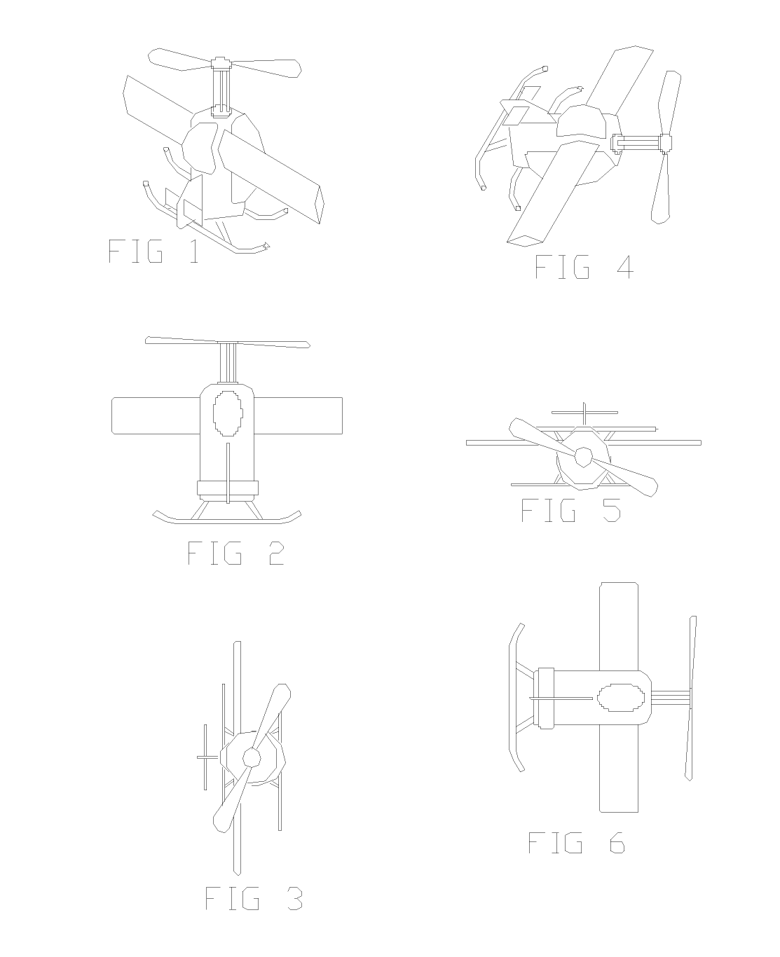

FIG. 1 depicts a perspective view of an embodiment of the invention sitting on the ground or in low-speed vertical flight mode. During take-off or landing, and during low-speed flight, lift and part of the flight control is provided by a set of rotating blades as in a conventional helicopter, and yaw is induced or limited by control surfaces on the fixed wing. FIG. 2 depicts a side view of the broad side of the fixed wing. In FIG. 3 only the leading edge of the fixed wings can be seen from this top view. The fixed wing works very well during takeoff and landing eliminating the need for a tail rotor. While traveling in low-speed vertical flight mode, a bonus mode of slowly moving in various directions, the fixed wing may produce some undesirable flight characteristics such as unwanted forces due to cross-winds. However, in fast-forward mode the fixed wing more than makes up for any low speed challenges by providing the very important stable lift required for high-speed flight faster than any conventional helicopter.

On takeoff in vertical flight mode once the aircraft has gained sufficient altitude, the pilot can use a conventional rotor control to roll the craft forward about an axis oriented along the length of the fixed wing. This maneuver accelerates the craft forward, inducing flow over the fixed wing, thereby transferring lift from the rotor to the fixed wing as the rotor's thrust accelerates the craft. Although the angle of attack of this wing initially exceeds the stall angle, the rotor is still providing some lift. As the craft rotates about the axis of the wings and accelerates forward, lift from the fixed wing increases as the lift from the rotor decreases. When the aircraft has completely rotated to fast-forward flight, the rotor supplies thrust as a conventional propeller and maintains control elements as the aircraft's lift is provided by air flowing over the fixed wing as depicted in FIGS. 4, 5, and 6. The entire transition has been accomplished without changing the basic craft's configuration in that no major component has moved with respect to any other major component.

Transition from fast-forward flight to low-speed flight requires reduction of flight speed. The pilot can use the rotor controls to roll the craft up to a helicopter-like orientation at which point it can be flown to landing as a helicopter.

### CONCLUSIONS, RAMIFICATIONS, AND SCOPE OF INVENTION

While the above description contains many specificities these should not be construed as limitations on the scope of the invention, but rather as exemplifications of one preferred embodiment thereof Many other variations are possible. For example, any mechanism producing appropriate thrust may be used instead of the aforementioned rotor. For example, minor elements such as sensors, displays, controls, lights, seats, or beds may rotate with respect to the major aircraft elements to maintain preferred orientation of that minor element. Accordingly the scope of the invention should be determined not by the embodiments illustrated but by the appended claims and their legal equivalents.

I claim:

1. A VTOL aircraft capable of fixed-wing aircraft speed comprising:
a) an airframe into which a payload such as human beings or freight can be loaded and to which major components that provide propulsion and/or lift are attached;
b) a system for producing a force used for lift during take-off, landing, and hover, for lift and propulsion in a relatively slow primarily horizontal flight mode, and for propulsion in fast forward flight mode, that does not change the general orientation of the force with respect to the airframe in any of these flight modes;
c) at least one surface providing lift due to flow past it during fast-forward flight that does not change general orientation with respect to the airframe in any flight modes.
